(19) United States
(12) Patent Application Publication
(10) Pub. No.: US 2024/0154105 A1
(43) Pub. Date: May 9, 2024

(54) BATTERY AND METHOD FOR PRODUCING THE SAME

(71) Applicant: Panasonic Intellectual Property Management Co., Ltd., Osaka (JP)

(72) Inventors: MASAKI HIRASE, Hyogo (JP); HIROKI YABE, Osaka (JP)

(21) Appl. No.: 18/406,080

(22) Filed: Jan. 5, 2024

Related U.S. Application Data
(63) Continuation of application No. PCT/JP2022/020876, filed on May 19, 2022.

(30) Foreign Application Priority Data
Jul. 28, 2021 (JP) 2021-123064

(51) Int. Cl. H01M 4/38; H01M 4/36; H01M 10/0525; H01M 10/0585

(52) U.S. Cl. CPC H01M 4/386; H01M 4/366; H01M 10/0525; H01M 10/0585; H01M 2004/027

(57) ABSTRACT

A battery includes: a positive electrode; a negative electrode; and a solid electrolyte layer disposed between the positive electrode and the negative electrode, in which the negative electrode includes a first negative electrode layer and a second negative electrode layer disposed between the first negative electrode layer and the solid electrolyte layer, the first negative electrode layer and the second negative electrode layer contain silicon, and the mole ratio of lithium to silicon in the second negative electrode layer is greater than the mole ratio of lithium to silicon in the first negative electrode layer.

### BACKGROUND

### 1. Technical Field

The present disclosure relates to a battery and a method for producing the same.

### 2. Description of the Related Art

All-solid-state secondary batteries have attracted attentions as non-aqueous electrolyte secondary batteries in recent years. An all-solid-state secondary battery includes, for example, a positive electrode, a negative electrode, and a solid electrolyte layer. The all-solid-state secondary battery uses a solid electrolyte as a medium conducting lithium ions.

For example, Japanese Unexamined Patent Application Publication Nos. 2020-21674 and 2019-106352 disclose non-aqueous electrolyte secondary batteries using a negative electrode containing a solid electrolyte.

### SUMMARY

In the prior arts, it is desirable that batteries using a solid electrolyte are improved in cycle characteristics and discharge rate characteristics.

In one general aspect, the techniques disclosed here feature a battery, including: a positive electrode; a negative electrode; and a solid electrolyte layer disposed between the positive electrode and the negative electrode, in which the negative electrode includes a first negative electrode layer and a second negative electrode layer disposed between the first negative electrode layer and the solid electrolyte layer, the first negative electrode layer and the second negative electrode layer contain silicon, and the mole ratio of lithium to silicon in the second negative electrode layer is greater than the mole ratio of lithium to silicon in the first negative electrode layer.

According to the present disclosure, it is possible to improve the cycle characteristics and discharge rate characteristics of batteries using a solid electrolyte.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic sectional view of a battery of an embodiment;

FIGS. 2A to 2C are schematic diagrams illustrating changes in Li content of a first negative electrode layer and a second negative electrode layer due to charge and discharge;

FIG. 3 is a plan view of the battery illustrated in FIG. 1; and

FIG. 4 is a process diagram illustrating a method for producing the battery of the embodiment.

### DETAILED DESCRIPTIONS

### Underlying Knowledge Forming Basis of the Present Disclosure

Active materials of non-aqueous secondary batteries are conventionally graphite. In recent years, silicon has been proposed as a negative electrode active material in order to improve the energy density of a non-aqueous secondary battery. Silicon is one of the materials that can be alloyed with lithium. The capacity of silicon per unit mass is greater than that of graphite. On the other hand, silicon significantly expands or contracts during charge and discharge. Batteries using silicon as the negative electrode active material therefore have a problem that their cycle characteristics are likely to degrade due to poor contact between particles of the active material, poor contact between particles of the active material and the current collector, or the like.

In an all-solid-state battery, interfaces between all the materials are solid-to-solid interfaces. The degradation in contact state at solid-to-solid interfaces due to expansion and contraction of active materials have a significant influence on the battery performance. When the negative electrode is composed of a material, such as silicon, that greatly expands and contracts during charge and discharge, in particular, the problem concerning degradation in cycle characteristics is more likely to occur. Since the solid electrolyte layer is disposed between the negative electrode and the positive electrode, poor contacts between particles in the vicinity of the interface between the negative electrode and the solid electrolyte layer can cause degradation in cycle characteristics.

In order to improve the battery performance by reducing degradation in contact state at solid-to-solid interfaces, it has been proposed to control the diameter of particles of the active materials. Japanese Unexamined Patent Application Publication No. 2020-21674 discloses that the change in battery volume due to charge or discharge is smaller when silicon particles as the active material have an average particle size of 0.19 μm than when silicon particles have an average particle size of 2.6 μm.

Furthermore, a method for producing an all-solid-state battery has been proposed which includes pre-doping the negative electrode active material with lithium. Japanese Unexamined Patent Application Publication No. 2019-106352 discloses that a material including graphite or lithium titanate doped with lithium is mixed into the negative electrode.

The inventors gave a great deal of consideration to the cycle characteristics and discharge rate characteristics of batteries using silicon as the negative electrode active material. As a result, the inventors found out that applying the lithium pre-doping technique was able to improve the cycle characteristics and discharge rate characteristics of such batteries and achieved the present disclosure.

### Summary of Aspect of Present Disclosure

A battery according to a first aspect of the present disclosure includes:
a positive electrode;
a negative electrode; and
a solid electrolyte layer disposed between the positive electrode and the negative electrode, in which
the negative electrode includes a first negative electrode layer and a second negative electrode layer disposed between the first negative electrode layer and the solid electrolyte layer,
the first negative electrode layer and the second negative electrode layer contain silicon, and
the mole ratio of lithium to silicon in the second negative electrode layer is greater than the mole ratio of lithium to silicon in the first negative electrode layer.

According to the first aspect, the cycle characteristics and the discharge rate characteristics of the battery using the solid electrolyte can be improved.

In a second aspect of the present disclosure, for example, in the battery according to the first aspect, the ratio of the mass of the silicon contained in the second negative electrode layer to the sum of the mass of the silicon contained in the first negative electrode layer and the mass of the silicon contained in the second negative electrode layer may be greater than or equal to 5 mass % and less than or equal to 60 mass %. By properly adjusting the content of silicon in the second negative electrode layer, stress produced in the interface between the second negative electrode layer and the solid electrolyte layer can be reduced significantly.

In a third aspect of the present disclosure, for example, in the battery according to the second aspect, the mass of the silicon contained in the second negative electrode layer may be greater than or equal to 10 mass % and less than or equal to 50 mass %. By properly adjusting the content of silicon in the second negative electrode layer, the stress produced in the interface between the second negative electrode layer and the solid electrolyte layer can be reduced significantly.

In a fourth aspect of the present disclosure, for example, in the battery according to the first aspect, the mass of the silicon contained in the second negative electrode layer may be equal to the mass of the silicon contained in the first negative electrode layer. According to such a configuration, the stress produced in the interface between the second negative electrode layer and the solid electrolyte layer can be reduced more effectively.

In a fifth aspect of the present disclosure, for example, in the battery according to the first aspect, the mass of the silicon contained in the second negative electrode layer may be smaller than the mass of the silicon contained in the first negative electrode layer. According to such a configuration, it is possible to provide a significant effect of stress reduction while minimizing the amount of lithium contained in the negative electrode before charge or discharge.

In a sixth aspect of the present disclosure, for example, in the battery according to any one of the first to fifth aspects, the mole ratio of lithium to silicon in the second negative electrode layer may be greater than or equal to 0.5 and less than or equal to 1.4. According to such a configuration, it is possible to reduce degradation in energy density of the battery.

In a seventh aspect of the present disclosure, for example, in the battery according to any one of the first to sixth aspects, the negative electrode may include a particular region not overlapping the positive electrode in plan view. In the particular region, the mole ratio of lithium to silicon in the second negative electrode layer may be greater than the mole ratio of lithium to silicon in the first negative electrode layer. According to such a configuration, it is possible to identify or estimate the presence or the concentration of lithium which the negative electrode is doped with before charge or discharge.

A method for producing a battery according to an eighth aspect of the present disclosure includes:
producing a negative electrode including a first negative electrode layer containing silicon and a second negative electrode layer containing silicon and lithium; and
laminating a positive electrode, a solid electrolyte layer, and the negative electrode on top of each other in this order such that the second negative electrode layer is positioned between the first negative electrode layer and the solid electrolyte layer, in which
the mole ratio of lithium to silicon in the second negative electrode layer is greater than the mole ratio of lithium to silicon in the first negative electrode layer.

According to the eighth aspect, the battery of the present disclosure can be efficiently manufactured. By separately producing the first negative electrode layer and the second negative electrode layer, the ratios of lithium to silicon in the first negative electrode layer and the second negative electrode layer can be individually adjusted.

Hereinafter, an embodiment of the present disclosure will be described with reference to the drawings.

### Embodiment

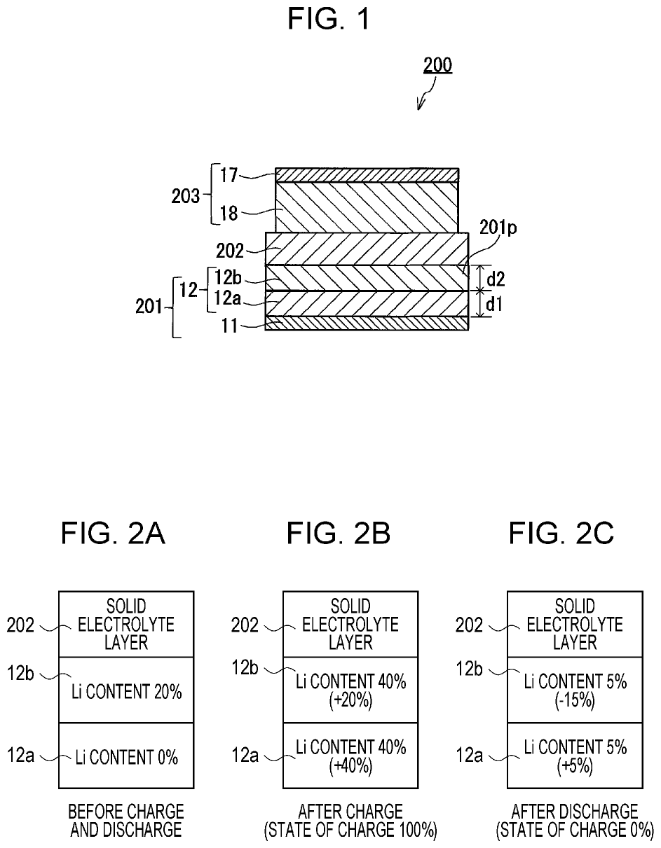

FIG. 1 is a sectional view of a schematic configuration of a battery 200 in the embodiment. The battery 200 includes a negative electrode 201, a solid electrolyte layer 202, and a positive electrode 203. The solid electrolyte layer 202 is disposed between the negative electrode 201 and the positive electrode 203. The negative electrode 201 stores and releases lithium during charge and discharge of the battery 200. The positive electrode 203 also stores and releases lithium during charge and discharge of the battery 200.

### Negative Electrode 201

The negative electrode 201 includes a negative electrode current collector 11 and a negative electrode active material layer 12. The negative electrode current collector 11 and the negative electrode active material layer 12 are in contact with each other. The negative electrode active material layer 12 is disposed between the negative electrode current collector 11 and the solid electrolyte layer 202. The negative electrode current collector 11 is composed of a conductive material, such as a metal material or a carbon material.

The negative electrode active material layer 12 includes a first negative electrode layer 12a and a second negative electrode layer 12b. The second negative electrode layer 12b is disposed between the first negative electrode layer 12a and the solid electrolyte layer 202. The first negative electrode layer 12a is in contact with the negative electrode current collector 11. The second negative electrode layer 12b is in contact with the solid electrolyte layer 202. The first negative electrode layer 12a is in contact with the second negative electrode layer 12b. A third layer may be disposed between the first negative electrode layer 12a and the second negative electrode layer 12b.

The negative electrode active material layer 12 contains silicon as a negative electrode active material. That is, the first and second negative electrode layers 12a and 12b contain silicon. Silicon can be a main component of the negative electrode active material layer 12. Silicon can be a main component of each of the first and second negative electrode layers 12a and 12b. The “main component” denotes the most abundant component in terms of mass proportion. In addition to silicon, the negative electrode active material layer 12 may contain a conductive assistant, a binder, or the like. In the negative electrode active material layer 12, silicon may be in a particulate form, a thin-film form, or a columnar form.

The second negative electrode layer 12b contains further amounts of lithium in the state where the battery 200 has been just assembled, that is, in the state where the battery 200 has neither been charged nor discharged. In other words, the second negative electrode layer 12b is previously doped with lithium. The first negative electrode layer 12a may contain lithium but is not required to. In other words, the first negative electrode layer 12a may be previously doped with lithium but is not required to. The lithium which the first negative electrode layer 12a is previously doped with is lithium that can be released from the negative electrode 201 through a discharge reaction. The mole ratio of lithium to silicon in the second negative electrode layer 12b is greater than that in the first negative electrode layer 12a.

FIGS. 2A to 2C are diagrams schematically illustrating changes in Li content of the first and second negative electrode layers 12a and 12b due to charge and discharge. FIG. 2A schematically illustrates the state of the first and second negative electrode layers 12a and 12b before charge and discharge. FIG. 2B schematically illustrates the state of the first and second negative electrode layers 12a and 12b after initial charge. FIG. 2C schematically illustrates the state of the first and second negative electrode layers 12a and 12b after initial discharge. The “Li content” in FIGS. 2A to 2C indicates a Li content of each layer with respect to the specific capacity (3861 mAh/g) of silicon being 100%. For example, when the Li content of the second negative electrode layer 12b is 20%, the second negative electrode layer 12b stores an amount of lithium corresponding to 20% of the capacity of silicon contained in the second negative electrode layer 12b. The “Li content” is proportional to the ratio of lithium to silicon, or specifically the ratio of the amount of substance of lithium to the amount of substance of silicon. When the “Li content” is large, the ratio of lithium to silicon is large. When the “Li content” is small, the ratio of lithium to silicon is small.

As illustrated in FIG. 2A, the Li content of the second negative electrode layer 12b is 20% before charge and discharge. The Li content of the first negative electrode layer 12a is 0%. This means that the second negative electrode layer 12b is previously doped with lithium, and the first negative electrode layer 12a is not doped with lithium.

Next, as illustrated in FIG. 2B, when initial charge is performed, the Li content of the second negative electrode layer 12b changes to 40%, and the Li content of the first negative electrode layer 12a changes to 40%. The amount of change in the Li content of the second negative electrode layer 12b is +20% with respect to the Li content before charge and discharge, and the amount of change in the Li content of the first negative electrode layer 12a is +40%. After the charge, the potential of the negative electrode active material layer 12 is constant, and lithium is uniformly distributed in the negative electrode active material layer 12. The Li content of the first negative electrode layer 12a is substantially equal to that of the second negative electrode layer 12b. The reason the Li contents of the first and second negative electrode layers 12a and 12b are both 40% even though the state of charge is 100% is that the battery 200 is designed such that the capacity of the positive electrode 203 is sufficiently smaller than that of the negative electrode 201. Such a configuration can reduce changes in volume of silicon in the negative electrode 201.

Next, as illustrated in FIG. 2C, when initial discharge is performed, the Li content of the second negative electrode layer 12b changes to 5%, and the Li content of the first negative electrode layer 12a also changes to 5%. The amount of change in the Li content of the second negative electrode layer 12b is −15% with respect to the Li content before charge and discharge, and the amount of change in the Li content of the first negative electrode layer 12a is +5%. The 5% remaining lithium corresponds to a so-called irreversible capacity.

The first and second negative electrode layers 12a and 12b both expand during charge and contract during discharge. With respect to the Li content before charge and discharge, the absolute value of the amount of change in the Li content of the second negative electrode layer 12b is 20% (at charge). With respect to the Li content before charge and discharge, the absolute value of the amount of change in the Li content of the first negative electrode layer 12a is 40% (at charge). The amount of lithium stored in the second negative electrode layer 12b during charge is smaller than the amount of lithium stored in the first negative electrode layer 12a. The volume expansion of silicon in the second negative electrode layer 12b is therefore smaller than that in the first negative electrode layer 12a. The second negative electrode layer 12b expands and contracts less than the first negative electrode layer 12a, and the stress produced in the interface between the second negative electrode layer 12b and the solid electrolyte layer 202 during charge and discharge can be reduced. In this case, the contact between the negative electrode 201 and the solid electrolyte layer 202 is easily maintained, and the cycle characteristics and discharge rate characteristics of the battery 200 can be improved. According to the embodiment, in particular, the second negative electrode layer 12b functions as a buffer layer, so that the contact between the negative electrode 201 and the solid electrolyte layer 202 is easily maintained.

According to the embodiment, furthermore, it is possible to reduce the total amount of lithium which the negative electrode 201 is doped with. As the total amount of lithium which the negative electrode 201 is doped with is reduced, the amount of lithium that can be stored by silicon of the negative electrode 201 during charge increases. This can reduce the need to increase the amount of silicon in the negative electrode 201 so that silicon in the negative electrode 201 can store all the lithium released from the positive electrode 203 during charge. It is therefore possible to reduce degradation in energy density of the battery 200.

As described with reference to FIGS. 2A to 2C, when the battery 200 is charged and discharged, the distribution of lithium in the negative electrode 201 is close to being uniform compared to the distribution of lithium before the battery 200 is charged or discharged. When the battery 200 has a structure described below, however, it is possible to identify or estimate the presence or the concentration of lithium which the negative electrode 201 is doped with before charge or discharge.

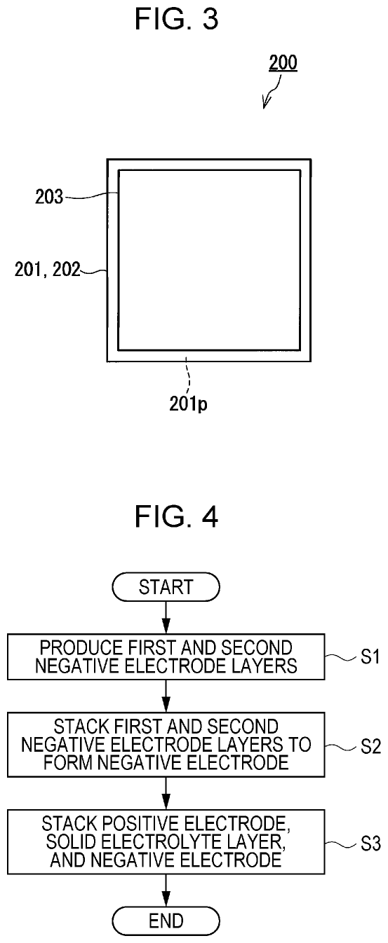

FIG. 3 is a plan view of the battery 200. The negative electrode 201 has a particular region 201p not overlapping the positive electrode 203 in plan view. The particular region 201p is provided in order to prevent the positive electrode 203 and the negative electrode 201 from short-circuiting at the edge of the battery 200 or to prevent metal lithium from precipitating at the edge of the negative electrode 201. Since the particular region 201p does not overlap the positive electrode 203, even after the battery 200 is repeatedly charged and discharged several times, the particular region 201p remains close to its initial state before the battery 200 is charged or discharged. Specifically, in the particular region 201p, the ratio of lithium to silicon in the second negative electrode layer 12b is greater than that in the first negative electrode layer 12a.

The ratios of lithium in the respective first and second negative electrode layers 12a and 12b can be determined by, for example, quantitative analyses of silicon and lithium at any measurement points in the first and second negative electrode layers 12a and 12b. The quantitative analyses of silicon and lithium are performed by inductively coupled plasma-mass spectrometry, energy dispersive X-ray spectroscopy, soft X-ray emission spectroscopy, or the like. The ratio of lithium to silicon may be calculated by averaging the values at multiple measurement points. The measurement points may be points at a cross section.

In the example illustrated in FIG. 3, the battery 200 has a rectangular shape in plan view. Each of the positive electrode 203, solid electrolyte layer 202, and negative electrode 201 also has a rectangular shape in plan view. The particular region 201p has a frame shape surrounding the positive electrode 203 in plan view. However, the shape of the particular region 201p is not limited. For example, the particular region 201p may be provided along one side of the rectangular battery 200, along two adjacent sides, or along two opposite sides.

The width of the particular region 201p is not limited and is, for example, greater than or equal to 0.5 mm and less than or equal to 5 mm. The width of the particular region 201p is the dimension thereof in a direction perpendicular to any side of the battery 200. Herein, the “any side of the battery 200” denotes a side observed in plan view of the battery 200.

The structure illustrated in FIG. 3 is not essential. For example, the shapes of the negative electrode 201, solid electrolyte layer 202, and positive electrode 203 may be identical to each other in plan view.

The contents of silicon in the first and second negative electrode layers 12a and 12b are not limited. In an example, the ratio (W2/(W1+W2)) of a mass W2 of silicon contained in the second negative electrode layer 12b to the sum (W1+W2) of a mass W1 of silicon contained in the first negative electrode layer 12a and the mass W2 of silicon contained in the second negative electrode layer 12b may be greater than or equal to 5 mass % and less than or equal to 60 mass % and may be greater than or equal to 10 mass % and less than or equal to 50 mass %. By properly adjusting the content of silicon in the second negative electrode layer 12b, the stress produced in the interface between the second negative electrode layer 12b and the solid electrolyte layer 202 can be significantly reduced.

The mass W2 of silicon contained in the second negative electrode layer 12b may be equal to the mass W1 of silicon contained in the first negative electrode layer 12a. According to such a configuration, the stress produced in the interface between the second negative electrode layer 12b and the solid electrolyte layer 202 can be reduced more effectively. Furthermore, the first negative electrode layer 12a and the second negative electrode layer 12b can be composed of the same materials.

Alternatively, the mass W2 of silicon contained in the second negative electrode layer 12b may be less than the mass W1 of silicon contained in the first negative electrode layer 12a. According to such a configuration, it is possible to provide a significant effect of stress reduction while minimizing the amount of lithium contained in the negative electrode 201 before charge or discharge.

In the embodiment, the shape of the first negative electrode layer 12a is the same as that of the second negative electrode layer 12b in plan view. In this case, the ratio (d2/(d1+d2)) of a thickness d2 of the second negative electrode layer 12b to the sum (d1+d2) of a thickness dl of the first negative electrode layer 12a and the thickness d2 of the second negative electrode layer 12b may be greater than or equal to 5% and less than or equal to 60% and may be greater than or equal to 10% and less than or equal to 50%. The thickness dl of the first negative electrode layer 12a may be the same as or different from the thickness d2 of the second negative electrode layer 12b.

The amount of lithium which the second negative electrode layer 12b is doped with is not limited. In an example, the ratio of lithium to silicon in the second negative electrode layer 12b is greater than or equal to 0.5 and less than or equal to 1.4. Specifically, the ratio (ML/MS) of an amount ML of substance of lithium contained in the second negative electrode layer 12b to an amount MS of substance of silicon contained in the second negative electrode layer 12b is greater than or equal to 0.5 and less than or equal to 1.4. The stable phase of the alloy of lithium and silicon is represented by Li_{4.4}Si. By adjusting the ratio (ML/MS) to greater than or equal to 0.5 and less than or equal to 1.4, the second negative electrode layer 12b can contain a proper amount of lithium that exceeds the irreversible capacity of silicon. As a result, the effect of stress reduction is expected to be optimized. Furthermore, when the ratio (ML/MS) is properly adjusted, the lithium doping can significantly reduce the resistance of the negative electrode 201. This can improve the discharge rate characteristics of the battery 200. When the ratio (ML/MS) is properly adjusted, still furthermore, the total amount of lithium which the negative electrode 201 is doped with can be reduced. As the total amount of lithium which the negative electrode 201 is doped with is reduced, the amount of lithium that can be stored in silicon of the negative electrode 201 during charge increases. This can reduce the need to increase the amount of silicon in the negative electrode 201 so that silicon of the negative electrode 201 can store all the lithium released from the positive electrode 203 during charge. It is therefore possible to reduce degradation in energy density of the battery 200.

The aforementioned ratio (ML/MS) is greater than the ratio (ML'/MS') of an amount ML' of substance of lithium contained in the first negative electrode layer 12a to an amount MS' of substance of lithium contained in the first negative electrode layer 12a.

### Solid Electrolyte Layer 202

The solid electrolyte layer 202 may contain a solid electrolyte having a lithium-ion conductivity. The technique of the present disclosure provides a sufficient effect even in lithium solid batteries.

The solid electrolyte contained in the solid electrolyte layer 202 is, for example, an inorganic solid electrolyte having a lithium-ion conductivity. The inorganic solid electrolyte is a sulfide solid electrolyte, an oxide solid electrolyte, a halide solid electrolyte, or the like.

The solid electrolyte contained in the solid electrolyte layer 202 may be a halide solid electrolyte.

The halide solid electrolyte is expressed by Composition Formula (1) below, for example. In Composition Formula (1), α, β, and β are values that are independent of each other and are greater than 0. M includes at least one element selected from the group consisting of metal elements and metalloid elements, other than Li. X includes at least one selected from the group consisting of F, Cl, Br, and I.

Li_{α}M_{β}X_{γ} . . . Composition Formula (1)

Metalloid elements include B, Si, Ge, As, Sb, and Te. Metal elements include all the elements contained in Groups 1 to 12 in the periodic table, except hydrogen, and all the elements contained in Groups 13 to 16, except B, Si, Ge, As, Sb, Te, C, N, P, O, S, and Se. In other words, metal elements are a group of elements that can become cations when forming an inorganic compound with a halide compound.

The halide solid electrolyte can be Li₃YX₆, Li₂MgX₄, Li₂FeX₄, Li(Al,Ga,In)X₄, Li₃(Al,Ga,In)X₆, or the like.

According to such a configuration, it is possible to improve the power density of the battery 200. Furthermore, it is possible to improve the thermal stability of the battery 200 and thereby inhibit production of toxic gas, such as hydrogen sulfide.

When an element in a composition formula is expressed like “(Al,Ga,In)” in the present disclosure, this expression represents at least one element selected from the group of elements in brackets. In other words, “(Al,Ga,In)” is synonymous with “at least one selected from the group consisting of Al, Ga, and In”. The same applies to other elements. The halide solid electrolyte has excellent ion conductivity.

In Composition Formula (1), M may include Y (yttrium). Specifically, the halide solid electrolyte contained in the solid electrolyte layer 202 may include Y as a metal element.

The halide solid electrolyte including Y may be a compound expressed by Composition Formula (2) below.

LiₐM_{b}Y_{c}X₆ . . . Composition Formula (2)

Composition Formula (2) satisfies a+mb+3c=6 and c>0. In Composition Formula (2), M includes at least one element selected from the group consisting of metal elements and metalloid elements, other than Li and Y. m is a valence of M. X includes at least one selected from the group consisting of F, Cl, Br, and I. M includes at least one selected from the group consisting of Mg, Ca, Sr, Ba, Zn, Sc, Al, Ga, Bi, Zr, Hf, Ti, Sn, Ta, and Nb. The halide solid electrolyte including Y specifically can be Li₃YF₆, Li₃YCl₆, Li₃YBr₆, Li₃YI₆, Li₃YBrCl₅, Li₃YBr₃Cl₃, Li₃YBr₅Cl, Li₃YBr₅I, Li₃YBr₃I₃, Li₃YBrI₅, Li₃YClI₅, Li₃YCl₃I₃, Li₃YCl₅I, Li₃YBr₂Cl₂I₂, Li₃YBrCl₄I, Li_{2.7}Y_{1.1}Cl₆, Li_{2.5}Y_{0.5}Zr_{0.5}Cl₆, Li_{2.5}Y_{0.3}Zr_{0.7}Cl₆, or the like.

According to such a configuration, the power density of the battery 200 can be further improved.

The solid electrolyte contained in the solid electrolyte layer 202 may include a sulfide solid electrolyte.

The sulfide solid electrolyte can be Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like. LiX, Li₂O, MO_{q}, LiₚMO_{q}, or the like may be added thereto. Herein, the element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. p and q in “MO_{q}” and “LiₚMO_{q}” are natural numbers independent of each other.

Examples of sulfide-based solid electrolyte can include lithium-containing sulfides, such as Li₂S—P₂S₅ series, Li₂S—SiS₂ series, Li₂S—B₂S₃ series, Li₂S—GeS₂ series, Li₂S—SiS₂—LiI, Li₂S—SiS₂—Li₃PO₄ series, Li₂S—Ge₂S₂ series, Li₂S—GeS₂—P₂S₅ series, and Li₂S—GeS₂—ZnS series.

The solid electrolyte contained in the solid electrolyte layer 202 may include at least one selected from the group consisting of oxide solid electrolytes, polymeric solid electrolytes, and complex hydride solid electrolytes.

Examples of the oxide solid electrolytes include NASICON-type solid electrolytes typified by LiTi₂(PO₄)₃ and its element substitutions, (LaLi)TiO₃-based perovskite-type solid electrolytes, LISICON-type solid electrolytes typified by Li₁₄ZnGe₄O₁₆, Li₄SiO₄, and LiGeO₄, and their element substitutions, garnet-type solid electrolytes typified by Li₇La₃Zr₂O₁₂ and its element substitutions, Li₃N and its H substitutions, Li₃PO₄ and its N substitutions, or glass or glass ceramics including a Li—B—O compound, such as LiBO₂ or Li₃BO₃, as a base material with Li₂SO₄, Li₂CO₃, or the like added thereto.

Examples of oxide-based solid electrolytes can include lithium-containing metal oxides, such as Li₂O—SiO₂ and Li₂O—SiO₂—P₂O₅, lithium-containing metal nitrides, such as LiₓP_{y}O_{1-z}N_{z}, and lithium-containing transition metal oxides, such as lithium phosphate (Li₃PO₄) and lithium titanate.

Specific examples of the oxide-based solid electrolytes include Li₇La₃Zr₂O₁₂ (LLZ), Li_{1.3}Al_{0.3}Ti_{1.7}(PO₄)₃ (LATP), and (La,Li)TiO₃ (LLTO).

The polymeric solid electrolyte can be, for example, a compound of a polymer compound and a lithium salt. The polymer compound may have an ethylene oxide structure. When having an ethylene oxide structure, the polymer compound is able to contain a large amount of lithium salt, further enhancing the ion conductivity. The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), or LiC(SO₂CF₃)₃. The polymeric solid electrolyte may include one selected from these lithium salts alone or may include a mixture of two or more selected from these lithium salts.

The complex hydride solid electrolyte can be, for example, LiBH₄—LiI, LiBH₄—P₂S₅, or the like.

The solid electrolyte layer 202 may contain only one solid electrolyte selected from the aforementioned group of solid electrolytes or may contain two or more solid electrolytes selected from the aforementioned group of solid electrolytes. The two or more solid electrolytes have different compositions. For example, the solid electrolyte layer 202 may contain a halide solid electrolyte and a sulfide solid electrolyte.

The thickness of the solid electrolyte layer 202 may be greater than or equal to 1 μm and less than or equal to 300 μm. When the thickness of the solid electrolyte layer 202 is greater than or equal to 1 μm, the negative electrode 201 and the positive electrode 203 are less likely to short-circuit. When the thickness of the solid electrolyte layer 202 is less than or equal to 300 μm, the battery 200 can operate at high output power.

### Positive Electrode 203

The positive electrode 203 includes a positive electrode current collector 17 and a positive electrode active material layer 18. The positive electrode current collector 17 and the positive electrode active material layer 18 are in contact with each other. The positive electrode active material layer 18 is disposed between the positive electrode current collector 17 and the solid electrolyte layer 202. The positive electrode 203 contributes to operation of the battery 200 as the counter electrode of the negative electrode 201. The positive electrode current collector 17 is composed of a conducting material, such as a metal material or a carbon material.

The positive electrode 203 contains a positive electrode active material. The positive electrode active material can be a material having properties of storing and releasing lithium ions. Examples of the positive electrode active material can be metal composite oxides, transition-metal fluorides, polyanion materials, fluorinated polyanion materials, transition-metal sulfides, transition-metal oxysulfides, or transition metal oxynitrides. When the positive electrode active material is a lithium-containing transition-metal oxide in particular, the battery 200 can be manufactured at low cost, and the average discharge voltage can be increased.

The metal composite oxide selected as the positive electrode active material contained in the positive electrode 203 may include Li and at least one element selected from the group of Mn, Co, Ni, and Al. Such a material is Li(NiCoAl)O₂, Li(NiCoMn)O₂, LiCoO₂, or the like. For example, the positive electrode active material may be Li(NiCoMn)O₂.

The positive electrode 203 may contain a solid electrolyte. According to such a configuration, the lithium ion conductivity within the positive electrode 203 can be improved, and the battery 200 can operate at high output power. The solid electrolyte in the positive electrode 203 may be selected from the materials exemplified as the solid electrolyte contained in the solid electrolyte layer 202.

The median diameter of particles of the active material contained in the positive electrode 203 may be greater than or equal to 0.1 μm and less than or equal to 100 μm. When the median diameter of the particles of the active material is greater than or equal to 0.1 μm, the particles of the active material and the solid electrolyte can be well dispersed. This can increase the charge capacity of the battery 200. When the median diameter of the particles of the active material is less than or equal to 100 the diffusion rate of lithium among the particles of the active material is maximized. The battery 200 therefore can operate at high output power.

The median diameter of the particles of the active material may be greater than that of the solid electrolyte. The active material and the solid electrolyte can be thereby well dispersed.

The volume ratio “v/100-v” of the active material to the solid electrolyte in the positive electrode 203 may satisfy 30≤v≤95. When 30≤v is satisfied, the energy density of the battery 200 is maximized. When v≤95 is satisfied, the battery 200 can operate at high output power.

The thickness of the positive electrode layer 203 may be greater than or equal to 10 μm and less than or equal to 500 μm. When the thickness of the positive electrode layer 203 is greater than or equal to 10 μm, the battery 200 provides a sufficient energy density. When the thickness of the positive electrode 203 is less than or equal to 500 μm, the battery 200 can operate at high output power.

The negative electrode 201 and the positive electrode 203 may contain one or more types of solid electrolytes for the purpose of enhancing the ion conductivity. The solid electrolytes may be selected from the materials exemplified as the solid electrolyte contained in the solid electrolyte layer 202.

At least one of the negative electrode 201, solid electrolyte layer 202, and positive electrode 203 may include a binder for the purpose of enhancing adhesion between particles. The binder is used to improve the binding properties between materials constituting each electrode. The binder can be polyvinylidene fluoride, polytetrafluoroethylene, polyethylene, polypropylene, aramid resin, polyimide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, carboxymethyl cellulose, ethyl cellulose, or the like. The binder also can be a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Furthermore, a mixture of two or more materials selected from these materials may be used as the binder. The binder may be styrene-ethylene-butylene-styrene block copolymer (SEBS) or maleic anhydride modified hydrogenated SEBS.

At least one of the negative electrode 201 and the positive electrode 203 may contain a conductive assistant for the purpose of enhancing electron conductivity. Examples of the conductive assistant can include graphites, such as natural graphite and synthetic graphite, carbon blacks, such as acetylene black and Ketjen black, conductive fibers, such as carbon fibers and metal fibers, metal powders, such as carbon fluoride powder and aluminum powder, conductive whiskers, such as zinc oxide whisker and potassium titanate whisker, conductive metal oxides, such as titanium oxide, and conductive polymer compounds, such as polyaniline, polypyrrole, and polythiophene. By using a carbon conductive assistant, the cost can be reduced.

The battery 200 may be configured as batteries having various shapes, including a coin shape, a cylindrical shape, a rectangular shape, a button shape, a flat shape, a laminated shape.

Next, a method for producing the battery 200 will be described. FIG. 4 is a process diagram illustrating the method for producing the battery 200 of the embodiment.

As illustrated in step Si, the first negative electrode layer 12a and the second negative electrode layer 12b are produced. For example, silicon particles and lithium metal are mixed in a mortar so that the silicon particles are doped with lithium. The silicon particles doped with lithium, the solid electrolyte, the conductive assistant, and a solvent are mixed to prepare a negative electrode slurry. The negative electrode slurry is applied to a support, such as a resin film, to form a coating film. The solvent is then removed from the coating film, and the second negative electrode layer 12b is thereby obtained. The first negative electrode layer 12a is obtained by using silicon particles not doped with lithium instead of the silicon particles doped with lithium and using the negative electrode current collector 11 instead of the resin film.

By adjusting the mass ratio of silicon particles to lithium metal, silicon particles doped with a high concentration of lithium and silicon particles doped with a low concentration of lithium can be produced. In an example, the second negative electrode layer 12b is produced using silicon particles doped with lithium while the first negative electrode layer 12a is produced using silicon particles not doped with lithium. In another example, the second negative electrode layer 12b is produced using silicon particles doped with a high concentration of lithium while the first negative electrode layer 12a is produced using silicon particles doped with a low concentration of lithium.

The method of doping silicon with lithium is not limited to the aforementioned method. For example, an active material sheet containing silicon particles not doped with lithium is produced. The method of producing the active material sheet may be either a wet process using a solvent or a dry process not using a solvent. The active material sheet is bonded to lithium metal foil, followed by heat treatment, or lithium metal is deposited on the active material sheet, followed by heat treatment. The second negative electrode layer 12b doped with lithium is thus obtained.

Next, as illustrated in step S2, the negative electrode current collector 11, the first negative electrode layer 12a, and the second negative electrode layer 12b are laminated on top of each other. The negative electrode 201 is thus obtained.

Next, as illustrated in step S3, the positive electrode 203, the solid electrolyte layer 202, and the negative electrode 201 are laminated on top of each other in this order such that the second negative electrode layer 12b is positioned between the first negative electrode layer 12a and the solid electrolyte layer 202. The second negative electrode layer 12b is in contact with the solid electrolyte layer 202. By performing the aforementioned processes, the battery 200 can be efficiently manufactured. Since the first negative electrode layer 12a and the second negative electrode layer 12b are separately produced, the ratios of lithium in the first negative electrode layer 12a and the second negative electrode layer 12b can be individually adjusted.

The processes in steps S2 and S3 can be carried out in the same step. Specifically, the positive electrode 203, the solid electrolyte layer 202, the second negative electrode layer 12b, and the first negative electrode layer 12a are laminated on top of each other in this order. The battery 200 are thus obtained.

The positive electrode 203 and the solid electrolyte layer 202 can be produced by another known process, such as a wet process or a dry process. In the wet process, a positive electrode slurry containing materials, including the positive electrode active material, solid electrolyte, and solvent, is applied to a support, such as the positive electrode current collector 17, to form a coating film. The solvent is removed from the coating film. The positive electrode active material layer 18 is thereby obtained. In the dry process, the positive electrode active material layer 18 is obtained by pressure-molding of a powder mixture containing materials, including the positive electrode active material and the solid electrolyte. These methods can be also applied to production of the solid electrolyte layer 202.

### EXAMPLES

Hereinafter, the detail of the present disclosure will be described using Examples and Comparative Examples. The present disclosure is not limited to Examples below.

### 1. Production of Solid Electrolyte

Li₂S and P₂S₅ were weighed in a mole ratio of Li₂S/P₂S₅=75/25 and were pulverized and mixed in a mortar. Next, the resulting mixture was subjected to 10-hour mechanical milling at 510 rpm using a planetary ball mill. Thus, a glassy sulfide solid electrolyte was obtained.

### 2. Doping of Silicon with Lithium

Silicon particles (the median diameter: 0.4 μm) and metal lithium were weighed in a mass ratio of (silicon particles)/(metal lithium)=84.4/15.6 and were kneaded in an agate mortar. Silicon particles doped with lithium were thus obtained. The mole ratio of lithium to silicon was 0.75. The mole ratio of lithium to silicon can be calculated by Expression (1) below:

$$( Mole ratio of Li to Si ) = ( Mass Ratio of Li / Atomic Weight of Li ) \text{} / ( Mass Ratio of Si / Atomic Weight of Si ) = ( 15.6 / 6.94 ) / ( 84.4 / 28.09 ) = 0.75 \qquad Expression ( 1 )$$

The specific capacity of lithium is 3861 mAh/g. The capacity value (capacity equivalent) corresponding to the total amount of lithium which silicon was doped with was 713 mAh per 1 g of silicon.

### 3. Evaluation of Charge and Discharge Characteristics of Negative Electrode Active Material

### (1) Production of Negative Electrode

The silicon doped with lithium, solid electrolyte, carbon fibers (VGCF-H by Showa Denko K. K.), and binder (M1913 by Asahi Kasei Corp.) were weighed in a mass ratio of 44/48/6.6/1.4 and were added with a dispersion medium. The resultant was kneaded to produce a negative electrode mixture slurry. The negative electrode mixture slurry was applied to a 10 μm thick copper foil to form a coating film. The coating film was dried at 100° C. A negative electrode a was thus obtained.

The silicon not doped with lithium, solid electrolyte, carbon fibers, and binder were weighed in a mass ratio of 47/44.5/7/1.5 and were added with a dispersion medium. The resultant was kneaded to produce a negative electrode mixture slurry. The negative electrode mixture slurry was applied to a 10 μm thick copper foil to form a coating film. The coating film was dried at 100° C. A negative electrode b was thus obtained.

The thicknesses of the negative electrodes a and b were adjusted such that the mass of silicon was 3.5 mg/cm². With regard to the silicon doped with lithium, the “mass of silicon” is the mass of silicon excluding the mass of lithium which the silicon is doped with.

### (2) Production of Battery

All-solid-state batteries a and b, which respectively include the negative electrodes a and b as a working electrode and include a lithium-indium alloy layer as a counter electrode, were produced through the following method.

First, 80 mg of the solid electrolyte was weighed and was put into an insulating cylinder. The inner diameter part of the insulating cylinder has a cross-sectional area of 0.7 cm². The solid electrolyte within the insulating cylinder was pressure-molded at a pressure of 50 MPa. Next, the negative electrode was punched out so as to have the same diameter as the inner diameter of the insulating cylinder. This negative electrode was placed on one of the surfaces of the solid electrolyte such that the negative electrode active material layer of the negative electrode was in contact with the solid electrolyte. Next, the negative electrode and solid electrolyte were pressure-molded at a pressure of 800 MPa to produce a laminated body composed of the negative electrode and the solid electrolyte. Next, on the solid electrolyte layer of the laminated body, metal indium, metal lithium, and metal indium were disposed in this order. The thickness of the metal indium was 200 μm. The area of the major surface of the metal indium was 0.66 cm². The thickness of the metal lithium was 300 μm. The area of the major surface of the metal lithium was 0.58 cm². Thus, a laminated body having a three-layer structure of the negative electrode, the solid electrolyte layer, and the indium-lithium-indium layer was produced.

Then, both end surfaces of the three-layer structure laminated body were sandwiched with stainless-steel pins. Furthermore, a confining pressure of 150 MPa was applied to the laminated body with bolts. The pins and bolts served as a confining member. Thus, the all-solid-state batteries a and b were obtained, which respectively include the negative electrodes a and b as the working electrode and include the lithium-indium alloy layer as the counter electrode.

### (3) Charge and Discharge Test

The battery a was discharged with a constant current of 0.65 mA/cm² at room temperature. The discharge of the battery a was performed until the potential of the working electrode reached 0.9 V with respect to the counter electrode. In this operation, the discharge means oxidation of the working electrode. The discharge capacity of the battery a measured in this process was shown in Table 1 as “Pre-discharge Capacity”. Each capacity shown in Table 1 is capacity per 1 g of silicon contained in the negative electrode a. With regard to silicon doped with lithium, the “1 g of silicon” refers to the mass of silicon excluding the mass of lithium which the silicon is doped with.

The silicon in the negative electrode a was doped with lithium, and the pre-discharge capacity of the battery a represents the amount of lithium released from silicon during the discharge. In the negative electrode a, the capacity equivalent of the total amount of lithium which silicon was doped with was 713 mAh per 1 g of silicon. During the pre-discharge of the battery a, therefore, about 57% of lithium which silicon was doped with was released.

Next, the battery a after the pre-discharge and the battery b were charged with a constant current of 0.65 mA/cm² at room temperature. The charge of the batteries a and b was performed until the potential of the working electrode reached −0.615 V with respect to the counter electrode. Then, the batteries a and b were discharged until the potential of the working electrode reached 0.9 V. In this operation, the charge means reduction of the working electrode, and the discharge means oxidation of the working electrode. The charge capacities, discharge capacities, and Coulombic efficiencies of the batteries a and b measured in this process are shown in Table 1.

The charge capacity of the battery b was 3186 mAh/g. This means that silicon not doped with lithium stored an amount of lithium corresponding to 3186 mAh/g in capacity equivalent.

The charge capacity and discharge capacity of the battery a were about 400 mAh/g smaller than those of the battery b, respectively. This suggests that lithium remained in the negative electrode a after the pre-discharge.

TABLE 1

| | | Pre- | | | |
|---|---|---|---|---|---|
| | | discharge | Charge | Discharge | Coulombic |
| | Working | Capacity | Capacity | Capacity | efficiency |
| | Electrode | (mAh/g) | (mAh/g) | (mAh/g) | (%) |
| Battery | Negative | 407 | 2711 | 2603 | 96.0 |
| a | Electrode a | | | | |
| Battery | Negative | Not | 3186 | 3021 | 94.8 |
| b | Electrode b | performed | | | |

### 4. Evaluation of Charge and Discharge Characteristics of Battery

### (1) Production of First Negative Electrode Layer

The silicon not doped with lithium, solid electrolyte, carbon fibers, and binder were weighed in a mass ratio of 47/44.5/7/1.5 and were added with a dispersion medium. The resultant was kneaded to produce a negative electrode mixture slurry. The negative electrode mixture slurry was applied to a 10 μm-thick copper foil to form a coating film. The coating film was dried at 100° C. Thus, a first negative electrode layer was obtained.

The amount of silicon per unit area was adjusted to produce three types of first negative electrode layers having different thicknesses. The three types of first negative electrode layers had capacities of 9.9, 5.5, and 11 mAh/cm².

### (2) Production of Second Negative Electrode Layer

The silicon doped with lithium, solid electrolyte, carbon fibers, and binder were weighed in a mass ratio of 44/48/6.6/1.4 and were added with a dispersion medium. The resultant was kneaded to produce a negative electrode mixture slurry. The negative electrode mixture slurry was applied to a 38 μm-thick polyethylene terephthalate (PET) film to form a coating film. The coating film was dried at 100° C. Thus, a second negative electrode layer was obtained.

The mass of silicon per unit area was adjusted to produce two types of second negative electrode layers having different thicknesses. The two types of second negative electrode layers had capacities of 1.1 and 5.5 mAh/cm².

### (3) Production of Negative Electrode

Three types of negative electrodes shown in Table 2 were produced through the following method.

The first negative electrode layer having a capacity of 9.9 mAh/cm² and the second negative electrode layer having a capacity of 1.1 mAh/cm² were laid on top of each other and were pressed using a plate press machine under the conditions of 80° C. and 200 MPa, thus forming a laminated body. The PET film of the second negative electrode layer was peeled off the laminated body. Thus, a negative electrode A1 was obtained.

A negative electrode A2 was produced in the same manner as the negative electrode A1 by using the first negative electrode layer having a capacity of 5.5 mAh/cm² and the second negative electrode layer having a capacity of 5.5 mAh/cm².

The first negative electrode layer having a capacity of 11 mAh/cm² was used as a negative electrode B.

TABLE 2

| | | Capacity of First | Capacity of Second |
|---|---|---|---|
| | | Negative Electrode | Negative Electrode |
| | | Layer (Not Doped) | Layer (Doped) |
| | Structure | (mAh/cm²) | (mAh/cm²) |
| Negative | Two-layered | 9.9 | 1.1 |
| Electrode A1 | | | |
| Negative | Two-layered | 5.5 | 5.5 |
| Electrode A2 | | | |
| Negative | Single-layered | 11 | None |
| Electrode B | | | |

### (4) Production of Positive Electrode

As the positive electrode active material, particles each having a core composed of Li(NiCoMn)O₂ and a coating layer composed of LiNbO₃ were produced. In a particle, the core was coated with the coating layer. The median diameter of the particles was 5 μm.

Next, the solid electrolyte was added to the positive electrode active material such that the mass ratio of the positive electrode active material to the solid electrolyte was 85/15. Then, the resulting mixture was added with the binder and the dispersion medium and was kneaded to produce a positive electrode mixture slurry. In the positive electrode mixture slurry, the sum of the mass of the positive electrode active material and the mass of the solid electrolyte to the mass of the binder was 98/2.

Next, the positive electrode mixture slurry was applied to the positive electrode current collector to form a coating film. The positive electrode current collector was a 15 μm thick aluminum foil. The coating film was dried at 100° C. Thus, a positive electrode was obtained.

### (5) Production of Solid Electrolyte Layer

The binder and the dispersion medium were added to the solid electrolyte, followed by kneading. Thus, a solid electrolyte mixture slurry was obtained. In the solid electrolyte mixture slurry, the ratio of the mass of the solid electrolyte to the mass of the binder was 100/2.

Next, the solid electrolyte mixture slurry was applied to a 38 μm thick PET film to form a coating film. The coating film was dried at 100° C. Thus, a solid electrolyte layer was obtained.

### (6) Laminating of Positive Electrode, Solid Electrolyte Layer, and Negative Electrode

The positive electrode and the solid electrolyte layer were laid on top of each other and were pressed using a plate press machine under the conditions of 80° C. and 200 MPa, thus forming a laminated body. The PET film of the solid electrolyte layer was peeled off the laminated body, and the resulting laminated body was punched out so as to have an area of 1 cm². Thus, a first laminated body including the positive electrode and the solid electrolyte layer was produced.

Then, the negative electrode A1 and the solid electrolyte layer were laid on top of each other and were pressed using a plate press machine under the conditions of 80° C. and 200 MPa, thus forming a laminated body. The PET film of the solid electrolyte layer was peeled off the laminated body, and the resulting laminated body was punched out so as to have an area of 1.5 cm². Thus, a second laminated body including the negative electrode A1 and the solid electrolyte layer was produced.

Next, the first laminated body and the second laminated body were laid on top of each other such that the solid electrolyte layers were in contact with each other and were pressed using a plate press machine under the conditions of 120° C. and 700 MPa. Thus, a battery element including the positive electrode/the solid electrolyte layer/the negative electrode was obtained. In this battery element, the entire positive electrode faced the negative electrode with the solid electrolyte layer interposed therebetween. The periphery of the negative electrode included a region that did not face the positive electrode with the solid electrolyte layer interposed therebetween.

The battery element was sealed in an aluminum laminate film provided with terminals. Thus, a battery A1 including the negative electrode A1 was obtained.

The battery element was sandwiched by rectangular metal plates, and bolts and nuts were attached to holes provided in four corners of each metal plate. By adjusting fastening torque of the bolts and nuts, a confining pressure of 1 MPa was applied to the battery element.

Batteries A2 and B were produced in the same manner as the battery A1, except for respectively using the negative electrodes A2 and B instead of the negative electrode A1.

### (7) Charge and Discharge Test

### (a) Coulombic Efficiency

Initial charge and discharge were performed for the batteries A1, A2, and B with a constant current of 0.44 mA at room temperature. The charge of the batteries A1, A2, and B was performed until their voltages reached 4.05 V. Next, the discharge of the batteries A1, A2, and B was performed until their voltages reached 2.5 V.

The charge capacity, discharge capacity, and Colomb efficiency in the initial charge and discharge of the batteries A1, A2, and B are shown in Table 3. The charge and discharge capacities in Table 3 are capacities of the positive electrode per unit area (1 cm²).

TABLE 3

| | Charge | Discharge | Coulombic |
|---|---|---|---|
| | Capacity | Capacity | efficiency |
| | (mAh/cm²) | (mAh/cm²) | (%) |
| Battery A1 | 4.4 | 4.0 | 90.6 |
| Battery A2 | 4.4 | 4.1 | 93.7 |
| Battery B | 4.3 | 3.7 | 86.0 |

As shown in Table 3, the batteries A1 and A2 exhibited more excellent Coulombic efficiencies than the battery B.

### (b) Evaluation of Cycle Characteristic and Discharge Rate Characteristic

Next, the cycle characteristics of batteries were evaluated by performing a cycle test through the following method. The discharge rate characteristics before and after the cycle test were also evaluated. The cycle characteristics are represented by a capacity retention. High capacity retention denotes excellent cycle characteristics. The discharge rate characteristics are represented by a 1 C/0.1 C discharge capacity ratio. The 1 C/0.1 C discharge capacity ratio is a ratio of the discharge capacity when discharge is performed with large current (1 C-rate) to the discharge capacity when discharge is performed with small current (0.1 C-rate) and is an index indicating whether the battery is suitable for discharge at large current.

First, each battery was charged with a constant current at 0.1 C rate (10-hour rate). The charge of the battery was performed until its voltage reached 4.05 V. Next, the charge of the battery was then performed with the voltage of the battery maintained at 4.05 V until the current value reached the value of 0.01 C rate. Next, the battery was discharged with a constant current at 0.1 C rate. The discharge of the battery was performed until its volage reached 2.5 V. The hour-rates of current at charge and discharge were determined based on the discharge capacity at the initial charge and discharge being 1-hour rate capacity.

Next, the battery was charged with a constant current at 1 C rate. The charge of the battery was performed until the voltage of the battery reached 4.05 V. Next, the battery was discharged with a constant current at 1 C rate. The discharge of the battery was performed until its voltage reached 2.5 V. The charge and discharge under these conditions were performed in 100 cycles.

In this specification, the test including 100 cycles of charge and discharge is sometimes referred to as a “cycle test”.

Subsequently, the battery was discharged with a constant current at 0.1 C rate until the voltage of the battery reached 2.5 V and then charged with a constant current at 0.1 C rate. The charge of the battery was performed until its voltage reached 4.05 V. Next, the charge of the battery was performed with the voltage of the battery maintained at 4.05 V until the current value reached the value of 0.01 C rate. Next, the battery was discharged with a constant current at 0.1 C rate. The discharge of the battery was performed until its volage reached 2.5 V.

The ratio of the discharge capacity in the first cycle of the cycle test to the discharge capacity in the 100th cycle is shown in Table 4 as “Capacity Retention”. The ratio of the discharge capacity in the first cycle of the cycle test to the discharge capacity at 0.1 C rate before the cycle test is shown in Table 4 as “1 C/0.1 C Discharge Capacity Ratio (Before Cycle Test)”. The ratio of the discharge capacity in the 100th cycle of the cycle test to the discharge capacity at the 0.1 C rate after the cycle test is shown in Table 4 as “1 C/0.1 C Discharge Capacity Ratio (After Cycle Test)”.

TABLE 4

| | Capacity | 1 C/0.1 C Discharge Capacity Ratio (%) | |
|---|---|---|---|
| | Retention | Before | After |
| | (%) | Cycle Test | Cycle Test |
| Battery A1 | 79 | 66 | 57 |
| Battery A2 | 86 | 68 | 63 |
| Battery B | 45 | 56 | 29 |

The batteries A1 and A2 exhibited more excellent capacity retentions and more excellent 1 C/0.1 C discharge capacity ratios than the battery B. That is, the batteries A1 and A2 were excellent in cycle characteristics and discharge rate characteristics.

The battery of the present disclosure is usable as power supplies for devices, for example, such as mobile electronic devices, electric vehicles, and power storage apparatuses.

What is claimed is:

1. A battery, comprising:
a positive electrode;
a negative electrode; and
a solid electrolyte layer disposed between the positive electrode and the negative electrode, wherein
the negative electrode includes a first negative electrode layer and a second negative electrode layer disposed between the first negative electrode layer and the solid electrolyte layer,
the first negative electrode layer and the second negative electrode layer contain silicon, and
the mole ratio of lithium to silicon in the second negative electrode layer is greater than the mole ratio of lithium to silicon in the first negative electrode layer.

2. The battery according to claim 1, wherein
the ratio of the mass of the silicon contained in the second negative electrode layer to the sum of the mass of the silicon contained in the first negative electrode layer and the mass of the silicon contained in the second negative electrode layer is greater than or equal to 5 mass % and less than or equal to 60 mass %.

3. The battery according to claim 2, wherein
the mass of the silicon contained in the second negative electrode layer is greater than or equal to 10 mass % and less than or equal to 50 mass %.

4. The battery according to claim 1, wherein
the mass of the silicon contained in the second negative electrode layer is equal to the mass of the silicon contained in the first negative electrode layer.

5. The battery according to claim 1, wherein
the mass of the silicon contained in the second negative electrode layer is smaller than the mass of the silicon contained in the first negative electrode layer.

6. The battery according to claim 1, wherein
the mole ratio of lithium to silicon in the second negative electrode layer is greater than or equal to 0.5 and less than or equal to 1.4.

7. The battery according to claim 1, wherein
the negative electrode includes a particular region not overlapping the positive electrode in plan view, and
in the particular region, the mole ratio of lithium to silicon in the second negative electrode layer is greater than the mole ratio of lithium to silicon in the first negative electrode layer.

8. A method for producing a battery, comprising:
producing a negative electrode including a first negative electrode layer containing silicon and a second negative electrode layer containing silicon and lithium; and
laminating a positive electrode, a solid electrolyte layer, and the negative electrode on top of each other in this order so that the second negative electrode layer is positioned between the first negative electrode layer and the solid electrolyte layer, wherein
the mole ratio of lithium to silicon in the second negative electrode layer is greater than the mole ratio of lithium to silicon in the first negative electrode layer.
